(19) United States
(12) Patent Application Publication
(10) Pub. No.: US 2016/0334029 A1
(43) Pub. Date: Nov. 17, 2016

(54) VALVE TRACKER

(71) Applicant: Heather French, Clinton, OK (US)

(72) Inventor: Heather French, Clinton, OK (US)

(21) Appl. No.: 14/709,762

(22) Filed: May 12, 2015

(51) Int. Cl. F16K 31/02; G01L 19/00; G01M 3/28; G01D 5/16

(52) U.S. Cl. CPC F16K 31/02; G01D 5/16; G01L 19/0092; G01M 3/2876

(57) ABSTRACT

A valve monitoring system includes: a programmable logic controller (PLC), where the programmable logic controller receives signals from sensors integrated into at least one valve; a linear potentiometer connected to a valve by a threaded fitting; a pneumatic actuator, where the pneumatic actuator includes a pneumatic sensor; position signals sent from the linear potentiometer to the PLC; pneumatic signals sent to the PLC from the pneumatic sensor; and data signals based upon the position signals and pneumatic signals. Preferably, a spring extends from a spring extends from the linear potentiometer to a metal plate that supports a diaphragm, where the metal plate pushes on the diaphragm to actuate the valve. The data signals sent from the PLC relate to conditions within the valve.

### BACKGROUND OF THE INVENTION

1. Field of Invention

The present invention relates to a system to detect and record signals related to pneumatic pressure within a valve.

2. Description of Related Art

Pneumatic pressure is a measurement that is related to the operation of control valves within various types of control systems. Control valves are used in various applications related to oil and gas pipeline systems to regulate the flow of liquid petroleum or natural gas. These valves must be maintained to ensure proper operation and to monitor any leakage within the valve. Many current systems require manual inspection of valves within such pipeline. Manual inspection inherently includes limitations due to reliance on human interaction. Further the monitoring of valves may not be available during non-working hours. As a consequence, it would be advantageous to have a system in place that monitor the activity of valves within a gas or oil pipeline. This monitoring of the valves enables quick correction and notification of system problems related to the operation of the valves.

### SUMMARY OF THE INVENTION

The present invention relates to a valve monitoring system includes: a programmable logic controller (PLC), where the programmable logic controller receives signals from sensors integrated into at least one valve; a linear potentiometer connected to a valve by a threaded fitting; a pneumatic actuator, where the pneumatic actuator includes a pneumatic sensor; position signals sent from the linear potentiometer to the PLC; pneumatic signals sent to the PLC from the pneumatic sensor; and data signals based upon the position signals and pneumatic signals. Preferably, a spring extends from a spring extends from the linear potentiometer to a metal plate that supports a diaphragm, where the metal plate pushes on the diaphragm to actuate the valve. The spring keeps the linear potentiometer registered on the diaphragm. The data signals sent from the PLC relate to conditions within the valve.

### BRIEF DESCRIPTION OF DRAWINGS

FIG. 1 depicts a valve detection system in accordance with the present invention.

### DETAILED DESCRIPTION

The present invention relates to a valve detection system that enables the monitoring of a pneumatically controlled valve. This system provides alerts and monitoring of the valve if the valve should have any leakage, fails to completely close or fails to open. This system helps to give an indication of maintenance regarding any needed repairs or replacements within the valve and effectively monitors the system. The valve monitoring system according to the present invention includes sensors on a valve actuator that transmits signals to a programmable logic controller. The signals provide an indication of any leakage or problems that may occur with respect to the operation of the valve actuator. The system according to present invention monitors the pneumatic pressure that is used to operate a diaphragm within a valve. As the pneumatic pressure is being monitored, a physical signal from the linear potentiometer is also being taken. The signals are sent to a programmable logic controller that compares the measurements to ensure that the pneumatic pressure within the valve and the position of the actuator are within tolerance. If the measurements are out of tolerance then signals are provided through the programmable logic controller notifying operators of issues that are affecting operation of a particular valve.

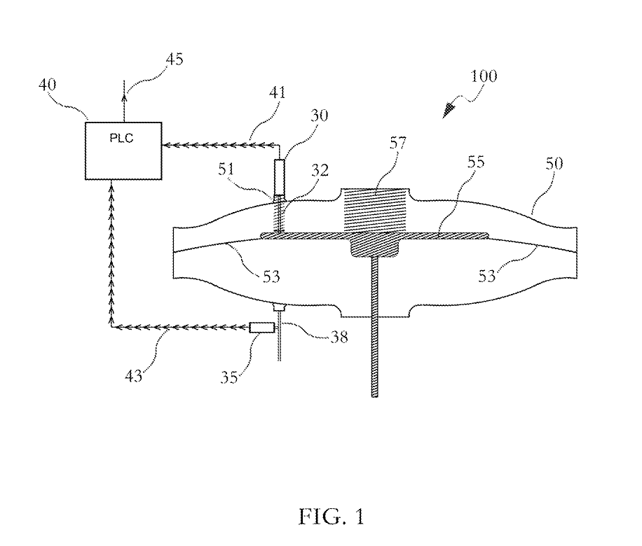

In reference to FIG. 1, a valve monitoring system 100 in accordance to the present invention is depicted. This valve monitoring system 100 is shown as connected to a valve actuator 50. The valve actuator 50 includes a diaphragm 53 that rests on a metal plate 55 to actuate the valve actuator 50. Above the metal plate 55 is a spring 57 that holds the valve in a closed position when no pressure is applied to the valve actuator 50. Furthermore, a spring 32 extends through the valve actuator 50 and abuts the metal plate 55. A linear potentiometer 30 is above the threaded fitting 51 that transmits position signals 41 to a programmable logic controller 40. The spring 32 keeps the shaft of the linear potentiometer 30 registered on to the shaft that the metal plate 55 actuates. A threaded fitting 51 affixes the linear potentiometer 30 to the valve actuator 50. On the underside of the valve actuator 50 is a pneumatic pressure line 38 that actuates the valve actuator 50. A pneumatic sensor 35 is connected to the pneumatic pressure line 38. This pneumatic sensor 35 samples the pressure to the valve actuator 50 and sends pneumatic signals 43 to the programmable logic controller 40. The controller 40 is able to compare the pneumatic signal 43 with the position signals 41 provided to determine the operation of the valve and any wear associated with the valve.

The programmable logic controller 40 transmits an output signal 45 to a graphic-controlled display provided for an operator. The graphic-controlled display although not shown provides an indication of the signals received by the programmable logic controller 40. These signals provided by the programmable logic controller 40 provide a measurement of the operation of valve actuator 50. This system may be implemented on multiple valves within a gas or oil pipeline system. The system assures that an alert is provided should any malfunction should occur with respect to the operation of the valve. Further the system provides an indication if the valve is not a completely closed position and therefore helps to ensure efficient and leak-free operation of a gas or oil pipeline. The instant invention has been shown and described in what it considers to be the most practical and preferred embodiments. It is recognized, however, that departures may be made there from within the scope of the invention and that obvious modifications will occur to a person skilled in the art.

What is claimed is:

1. A valve monitoring system comprising:
a. a programmable logic controller (PLC), where the programmable logic controller receives signals from sensors integrated into at least one valve;
b. a linear potentiometer connected to a valve by a threaded fitting;
c. a pneumatic actuator, where the pneumatic actuator includes a pneumatic sensor;
d. position signals sent from the linear potentiometer to the PLC;
e. pneumatic signals sent to the PLC from the pneumatic sensor; and
f. data signals based upon the position signals and pneumatic signals.

2. The valve monitoring system according to claim 1, where a spring extends from the linear potentiometer to a metal plate that supports a diaphragm.

3. The valve monitoring system according to claim 2, where the metal plate pushes on the diaphragm to actuate the valve.

4. The valve monitoring system according to claim 1, where the data signals relate to conditions within the valve.
